(19) United States
(12) Patent Application Publication
(10) Pub. No.: US 2025/0339834 A1
(43) Pub. Date: Nov. 6, 2025

(54) Internal Support System for a Stirred Tank Reactor

(71) Applicant: Sunflower Therapeutics, PBC, Hingham, MA (US)

(72) Inventors: Alexandra Bonnyman, Weymouth, MA (US); Akshada Shinde, Medford, MA (US)

(21) Appl. No.: 18/656,419

(22) Filed: May 6, 2024

(51) Int. Cl. B01J 19/18; B01J 4/00; B01J 19/00

(52) U.S. Cl. CPC B01J 19/18; B01J 4/004; B01J 19/006; B01J 19/0066; B01J 2204/002; B01J 2219/00186; B01J 2219/00777

(57) ABSTRACT

An internal support system for a stirred tank reactor includes at least one plate securable to one or more axial positions within a vessel of the stirred tank reactor along an impeller axis. The at least one plate has an outer portion at least partially defining a primary opening and a plurality of peripheral openings radially spaced from the primary opening. The at least one plate may further include an inner portion positioned within the primary opening and fixed to the outer portion, the inner portion being disposable about the impeller axis and at least partially defining a central opening sized to receive a rotatable impeller shaft therethrough. Each opening of the plurality of peripheral openings may be coaxial with a different port of a headplate of the stirred tank reactor when the at least one plate is secured to the axial position within the vessel.

### FIELD

The present disclosure, according to some embodiments, relates to an internal support system for a stirred tank reactor and components thereof. In some embodiments, the present disclosure relates to a stirred tank reactor including an internal support system.

### BRIEF SUMMARY

The present disclosure, according to some embodiments, provides an internal support system for a stirred tank reactor. The stirred tank reactor may generally include, for example, a vessel defining an interior space configured to contain a liquid, an impeller shaft positioned at least partially within the interior space of the vessel extending along an impeller axis, and an impeller fixed to the impeller shaft within the vessel and rotatable about the impeller axis according to some embodiments. In some embodiments, the stirred tank reactor may be configured as a bioreactor, e.g., a single-use bioreactor, which is suitable for use in cell culture, microbiology, and/or pharmaceutical production processes, for example. In some embodiments, the vessel may be rigidly constructed to be dimensionally stable such that an interior volume of the vessel remains constant. In further embodiments, the stirred tank reactor additionally includes a head plate positioned at an end of the vessel. The headplate may include a plurality of ports for receiving additional components (e.g., reactor instruments) that may be at least partially inserted through these ports and into the interior of the vessel. For example, these additional components may optionally include but are not limited to cell retention devices, tubing, sensors, probes, or other instruments, etc.

The internal support system, according to some embodiments, includes at least a first plate securable within the vessel at a first axial position along the impeller axis. In some embodiments, the first plate includes a first outer portion at least partially defining a first primary opening, and a first inner portion positioned within the first primary opening and fixed to the first outer portion. In some embodiments, the first inner portion at least partially defines a first central opening that is sized to receive the impeller shaft therethrough such that the impeller shaft is rotatable with respect to the first inner portion about the impeller axis. In some embodiments, the first primary opening has a broadest dimension that is greater than a diameter of the impeller. In some embodiments, the first central opening has a broadest dimension that is smaller than a diameter of the impeller.

In some embodiments, the first outer portion of the first plate includes a first plurality of peripheral openings that are radially spaced from the first primary opening. In some embodiments, when the first plate is secured to the first axial position, each opening of the first plurality of openings is coaxial with a different port of the headplate. In some such embodiments, each opening of the first plurality of openings may be coaxial with a different port of the headplate along a separate axis that is parallel to the impeller axis. In some embodiments, the openings of the first plurality of peripheral openings may each be sized and configured to receive one or more of the additional components (e.g., cell retention device, tubing, sensors, probes, or other instruments, etc.). In some embodiments, the first plurality of peripheral openings assists in guiding the insertion of these additional components into the vessel. In some embodiments, the openings of the first plurality of peripheral openings are sized and positioned to maintain the spatial arrangement of these additional components within the vessel and to prevent collisions of these additional components with each other and/or the impeller.

In further embodiments, the present disclosure provides a stirred tank reactor that includes a vessel for containing a liquid, the vessel having a proximal end and a distal end, an impeller shaft within the vessel disposed along and rotatable about an impeller axis, the impeller axis extending through the proximal end and the distal end of the vessel, an impeller secured to the impeller shaft within the vessel and rotatable with the impeller shaft about the impeller axis, a headplate coupled to the proximal end of the vessel having a plurality of ports spaced radially outward from the impeller axis, and an internal support system positioned within the vessel. In some embodiments, the internal support system includes one or more plates. In some embodiments, the one or more plates includes a first plate secured to a first axial position within the vessel along the impeller axis. In some embodiments, the first plate includes a first outer portion at least partially defining a first primary opening having a broadest dimension greater than a diameter of the impeller, the first outer portion including a first plurality of peripheral openings radially spaced from the first primary opening, wherein each opening of the first plurality of peripheral openings is coaxial with a different port of the headplate. In some embodiments, the first plate further includes a first inner portion positioned within the first primary opening and fixed to the first outer portion, the first inner portion disposed about the impeller axis and at least partially defining a first central opening sized to receive the impeller shaft therethrough, the impeller shaft being rotatable with respect to the first inner portion and the first outer portion.

In some embodiments, the first outer portion of the first plate comprises a ring that encircles the first primary opening, and the broadest dimension of the first primary opening is an inner diameter of the ring. In some embodiments, the first outer portion is disposed concentrically about the first inner portion. In some embodiments, the first primary opening is coaxial with the first central opening along the impeller axis. In some embodiments, the first central opening has a broadest dimension less than the diameter of the impeller. In some embodiments, each opening of the first plurality of peripheral openings is coaxial with a different port of the headplate along a separate axis. In some embodiments, each separate axis is parallel to the impeller axis. In some embodiments, each opening of the first plurality of peripheral openings is defined by a concave cylindrical surface that is disposed at least partially around the opening. The concave cylindrical surface may or may not be threaded. In some embodiments, at least one opening of the first plurality of peripheral openings is threaded. In other embodiments, no opening of the first plurality of peripheral openings is threaded. In some embodiments, at least one opening of the first plurality of peripheral openings is surrounded by a boss extending from a proximal face of the first plate. In some embodiments, each opening of the first plurality of peripheral openings has a broadest dimension that is less than an inner radius of the first outer portion. In some embodiments, at least one opening of the first plurality of peripheral openings has a broadest dimension that is greater than a broadest dimension of the first central opening.

In some embodiments, the first plate is securable to a wall of the vessel at the first axial position. In some embodiments, the first plate is securable to a structure within the vessel that is fixed in position relative to the vessel. The structure may be positioned radially outside of the first outer portion of the first plate. In some embodiments, the first plate is secured to the structure by at least one of adhesion, welding, a magnetic fastener, a mechanical fastener, and/or a fastener-less joint. In some embodiments, the first plate is secured to the structure by a fastener-less joint, the fastener-less joint including, for example, a tongue and groove joint, a dovetail joint, a mortise and tenon joint, and/or a lap joint. In some embodiments, the first plate is engaged with the structure by a coupling to secure the first plate to the structure, the coupling including a slot in one of the structure and the first plate, and a peg extending from the other one of the structure and the first plate received in the slot. In some embodiments, the first plate includes a coupling member extending radially from a periphery of the first plate, and the peg extends orthogonally from the coupling member. In some embodiments, the structure includes at least one baffle. In some embodiments, the at least one baffle includes a longest dimension that extends along a baffle axis that is parallel to the impeller axis. In some embodiments, the at least one baffle is positioned between the first outer portion of the first plate and a wall of the vessel. In some embodiments, the at least one baffle extends to the distal end of the vessel.

In some embodiments, the stirred tank reactor further includes a sparge ring positioned between the first plate and the distal end of the vessel. In some embodiments, the sparge ring at least partially defines a gas conduit and a plurality of outlets fluidically coupled to the gas conduit. In some embodiments, the sparge ring is coaxially positioned relative to the first outer portion on a distal face of the first outer portion. In some embodiments, the sparge ring is fixed to the distal face of the first outer portion, for example, by welding or by mechanical fastening. In some embodiments, the gas conduit includes a groove in a proximal surface of the sparge ring, and each outlet of the plurality of outlets extends from the groove to a surface of the sparge ring (e.g., a distal surface of the sparge ring). In some embodiments, the groove is an annular groove that is coaxial with the first outer portion. In some embodiments, at least some outlets of the plurality of outlets extends from the groove to a distal surface of the sparge ring. In some embodiments, the distal face of the first outer portion partially encloses the groove and defines a wall of the gas conduit. In some embodiments, at least one opening of the first plurality of peripheral openings overlays the groove at the proximal surface of the sparge ring and is fluidically coupled to the gas conduit. In some embodiments, the first plate further includes at least one radial spoke connecting the first inner portion to the first outer portion, and the sparge ring includes a support for abutting the at least one radial spoke. In some embodiments, one of the sparge ring and the first plate includes a keyed feature and the other one of the sparge ring and the first plate includes a keyway for receiving the keyed feature such that the sparge ring can be coupled to the first plate in only one orientation. In some embodiments, the keyed feature includes a projection on a proximal surface of the sparge ring, and the keyway includes a surface on the first outer portion having a contour that conforms to the projection.

In some embodiments, the internal support system further includes at least a second plate. In some embodiments, the second plate may have the same size and shape as the first plate. In some embodiments, the second plate is secured to a second axial position within the vessel along the impeller axis. In some embodiments, the first axial position is located between the impeller and the distal end of the vessel, and the second axial position is located between the impeller and the proximal end of the vessel. In some embodiments, the second plate includes a second outer portion at least partially defining a second primary opening having a broadest dimension greater than a diameter of the impeller, the second outer portion including a second plurality of peripheral openings radially spaced from the second primary opening, wherein each opening of the second plurality of peripheral openings is coaxial with one opening of the first plurality of peripheral openings. In some embodiments, the second plate further includes a second inner portion positioned within the second primary opening and fixed to the second outer portion, the second inner portion disposed about the impeller axis and at least partially defining a second central opening sized to receive the impeller shaft, the impeller shaft being rotatable with respect to the second inner portion and second outer portion. In some embodiments, each opening of the second plurality of peripheral openings is further coaxial with a port of the headplate.

In some embodiments, a stirred tank reactor includes at least one reactor instrument extending through one opening of the first plurality of peripheral openings and one opening of the second plurality of peripheral openings. The at least one reactor instrument may include, for example, at least one of a fluid conduit, a cell retention device (CRD), dip tube, or a sensor (e.g., a temperature probe, a pH probe, a dissolved oxygen probe, a gas sensor, or a biomass sensor). In some embodiments, the reactor instrument further extends through a port of the headplate. In some embodiments, the reactor instrument extends between the one opening of the first plurality of peripheral openings and the one opening of the second plurality of peripheral openings along an axis that is parallel to the impeller axis. In some embodiments, the one opening of the first plurality of peripheral openings and the one opening of the second plurality of peripheral openings are sized to prevent or at least restrict radial movement of the reactor instrument towards or away from the impeller shaft. In some embodiments, the one opening of the first plurality of peripheral openings and the one opening of the second plurality of peripheral openings are shaped such that the reactor instrument can be received in only one orientation through the one opening of the first plurality of peripheral openings and the one opening of the second plurality of peripheral openings.

### BRIEF DESCRIPTION OF THE DRAWINGS

The foregoing summary, as well as the following detailed description, will be better understood when read in conjunction with the appended drawings. For the purpose of illustrating the present disclosure, there are shown in the drawings embodiments which are presently preferred, wherein like reference numerals indicate like elements throughout. It should be noted, however, that aspects of the present disclosure can be embodied in different forms and thus should not be construed as being limited to the illustrated embodiments set forth herein. The elements illustrated in the accompanying drawings are not necessarily drawn to scale, but rather, may have been exaggerated to highlight the important features of the subject matter therein. Furthermore, the drawings may have been simplified by omitting elements that are not necessarily needed for the understanding of the disclosed embodiments.

FIG. 1A is a perspective view of a stirred tank reactor having an internal support system according to an illustrative embodiment of the present disclosure;

FIG. 1B is a partial bottom perspective view of the stirred tank reactor with the vessel removed for clarity illustrating various optional components supported by the internal support system according to certain embodiments of the present disclosure;

FIG. 2 is an elevational view of the stirred tank reactor of FIG. 1 with certain internal components omitted for clarity;

FIG. 3A is a top perspective view of a plate for an internal support system in accordance with certain embodiments of the present disclosure;

FIG. 3B is a bottom perspective view of the plate of FIG. 3A in an embodiment where the plate includes a sparge ring;

FIG. 4 is a plan view of the first plate superimposed over an impeller of the stirred tank reactor according to some embodiments;

FIG. 5A is bottom plan view of a headplate for the stirred tank reactor of FIG. 1 showing an arrangement of ports according to an example embodiment;

FIG. 5B shows the headplate of FIG. 5A superimposed with a plate of the internal support system;

FIG. 6 is a partial bottom perspective view of the internal support system having at least a first plate and second plate and showing the coaxial alignment of the peripheral openings of the plates and ports of the headplate according to certain embodiments;

FIG. 7 is a partial perspective view showing the plate of FIGS. 3A and 3B secured to one or more structures (e.g., baffles) and receiving an impeller shaft;

FIG. 8A is a perspective view of an internal support system having at least a first and second plate axially spaced from each other and secured to one or more baffles according to certain embodiments;

FIG. 8B is a perspective view of the internal support system of FIG. 8A positioned within a vessel of a stirred tank reactor according to some embodiments;

FIGS. 9A and 9B are top and bottom exploded views of the plate and sparge ring of FIG. 3B;

FIG. 10 is an isolated view of the sparge ring of FIGS. 9A and 9B;

FIG. 11A is a cross-sectional view of the plate and sparge ring of FIG. 3B; and

FIG. 11B is a cross-sectional view of the first plate and sparge ring of FIG. 11A with inlet tubing according to some embodiments.

### DETAILED DESCRIPTION

The present subject matter will now be described more fully hereinafter with reference to the accompanying Figures, in which representative embodiments are shown. The present subject matter can, however, be embodied in different forms and should not be construed as limited to the embodiments set forth herein. Rather, these embodiments are provided to describe and enable one of skill in the art. All publications, patent applications, patents, and other references mentioned herein are incorporated by reference in their entirety.

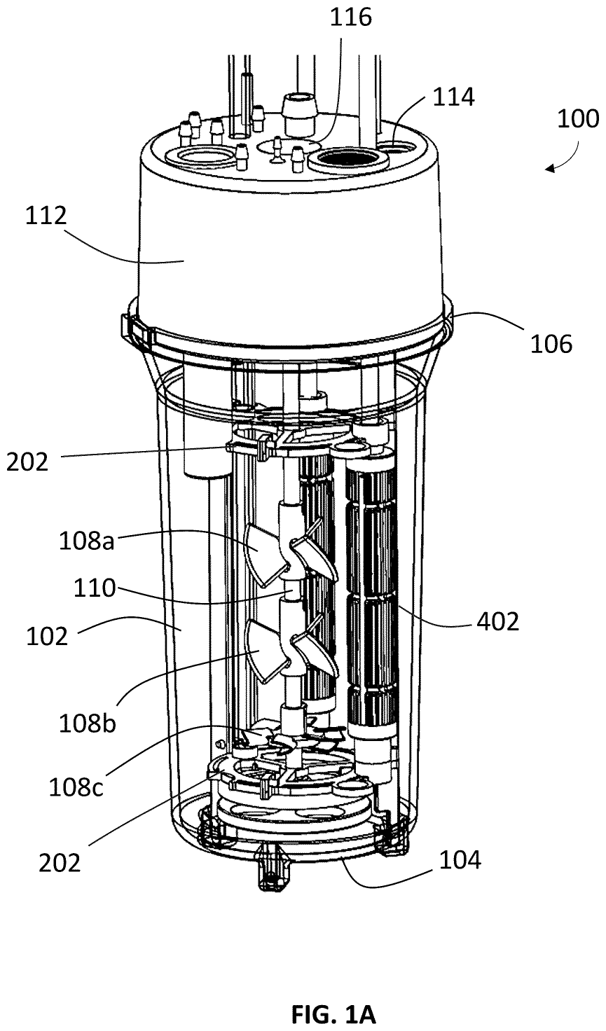

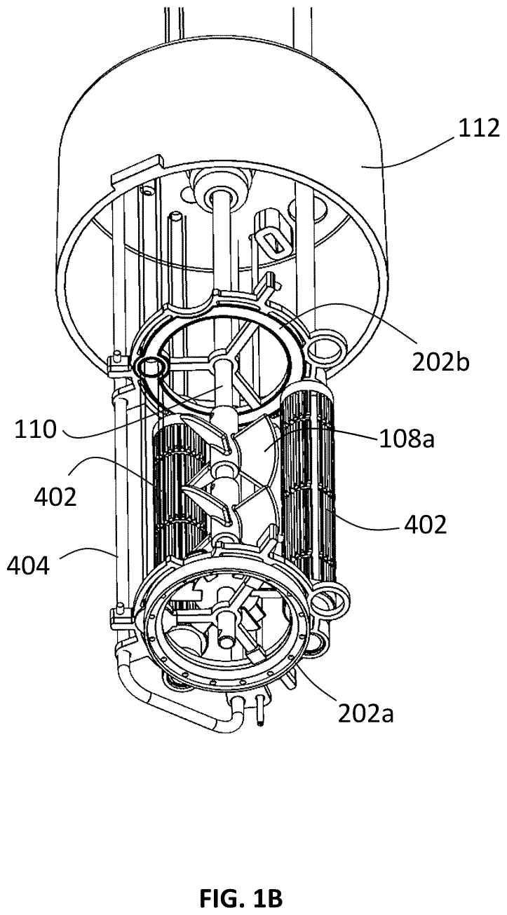

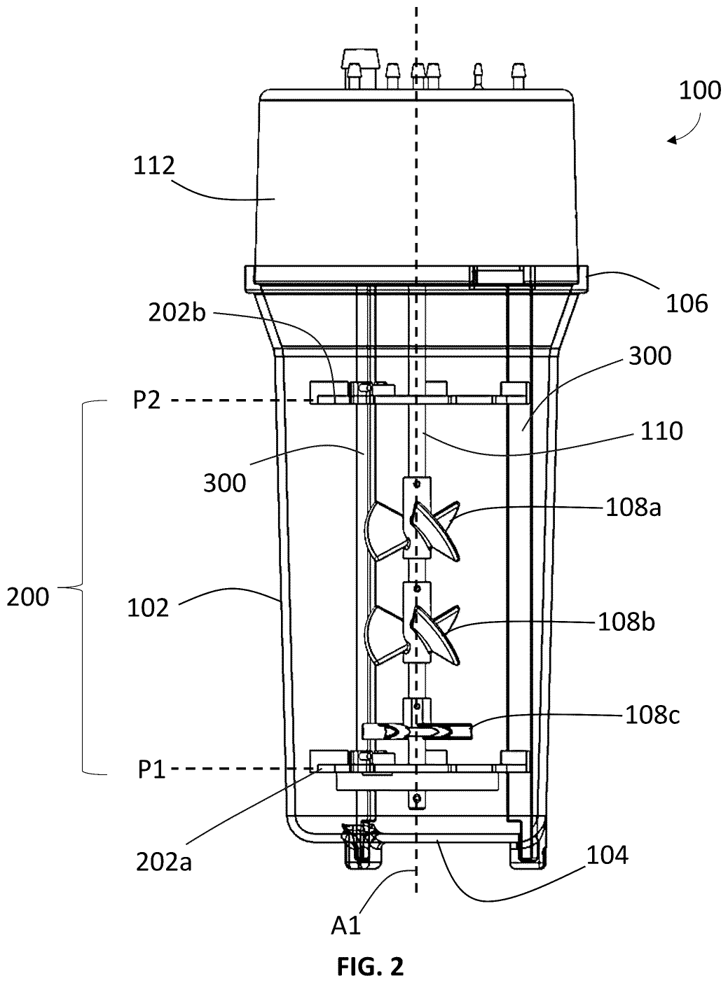

With reference to FIGS. 1A-2, there is shown a stirred tank reactor, generally designated 100, in accordance with certain embodiments of the present disclosure. In some embodiments, stirred tank reactor 100 may, for example, be configured for use as a bioreactor, e.g., a single-use bioreactor or a multi-use bioreactor. A single-use bioreactor may include components that are intended to be disposed of after a single use whereas a multi-use bioreactor may include components that can be sterilized for reuse. By way of example, in some embodiments, stirred tank reactor 100 may be configured for use in cell culture, microbiology, fermentation, and/or pharmaceutical production processes. However, stirred tank reactor 100 is not necessarily limited to such uses and may be configured for other applications according to other embodiments, for example, chemical mixing tanks, batch reactors, etc.

Stirred tank reactor 100, according to some embodiments, includes a vessel 102 that defines an interior reaction chamber and is configured for containing liquid materials. In some embodiments, vessel 102 may be rigidly constructed such that vessel 102 is dimensionally stable and has a constant interior volume. In some embodiments, vessel 102 may include a distal end 104 and a proximal end 106 opposite the distal end 104. As depicted in the illustrated embodiment, vessel 102 may be vertically oriented such that the distal end 104 is located at a bottom of vessel 102 and proximal end 106 is positioned at a top of vessel 102. In some such embodiments, distal end 104 is closed while proximal end 106 may be open to allow access into the interior reaction chamber within vessel 102. The distance between distal end 104 and proximal end 106 may be referred to herein as the “height” of vessel 102.

In further embodiments, stirred tank reactor 100 includes one or more impellers that are positioned within vessel 102 and configured to rotate with respect to vessel 102 about an impeller axis A1. During use, the impellers rotate about impeller axis A1 to cause fluid motion and stirring of the fluid within vessel 102. Impeller axis A1, in some embodiments, extends through proximal end 106 and distal end 104 of vessel 102. In some embodiments, impeller axis A1 may be coaxial with the central longitudinal axis of vessel 102. In other embodiments (not shown), impeller axis A1 may be offset from and/or obliquely angled with respect the central longitudinal axis of vessel 102. As shown in the illustrated examples, stirred tank reactor 100 includes three impellers 108a, 108b, 108c, however other embodiments may include less than or more than three impellers. In some embodiments, the one or more impellers 108a, 108b, 108c are each fixed to a rotatable impeller shaft 110 that extends along and is rotatable about impeller axis A1. The one or more impellers 108a, 108b, 108c may be positioned at different axial positions on impeller shaft 110 and may be secured to impeller shaft 110 or integrally formed therewith. Impeller shaft 110 may further be connected to a drive motor (not shown) that is configured to rotate impeller shaft 110 and impellers 108a, 108b, 108c about impeller axis A1 to cause fluid motion within vessel 102 during use. In some embodiments, the one or more impellers 108a, 108b, 108c are shaped and configured to cause axial and/or radial fluid movement within vessel 102 when rotated about impeller axis A1. Impellers 108a, 108b, 108c may have various blade shapes and are not necessarily limited to the illustrated configurations. For example, the one or more impellers 108a, 108b, 108c may be configured as a pitched-blade impeller, scooped-blade impeller, helical screw or helical ribbon impeller, anchor impeller, marine-style impeller, Rushton impeller, flat blade impeller, etc. When more than one impeller is present, the impellers may or may not have the same blade shapes.

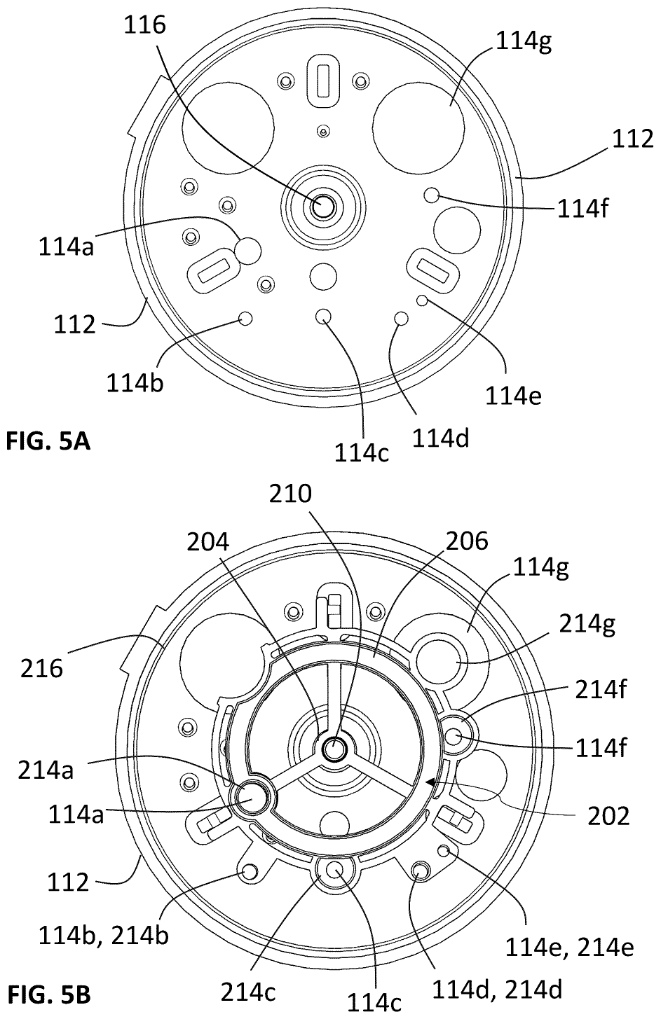

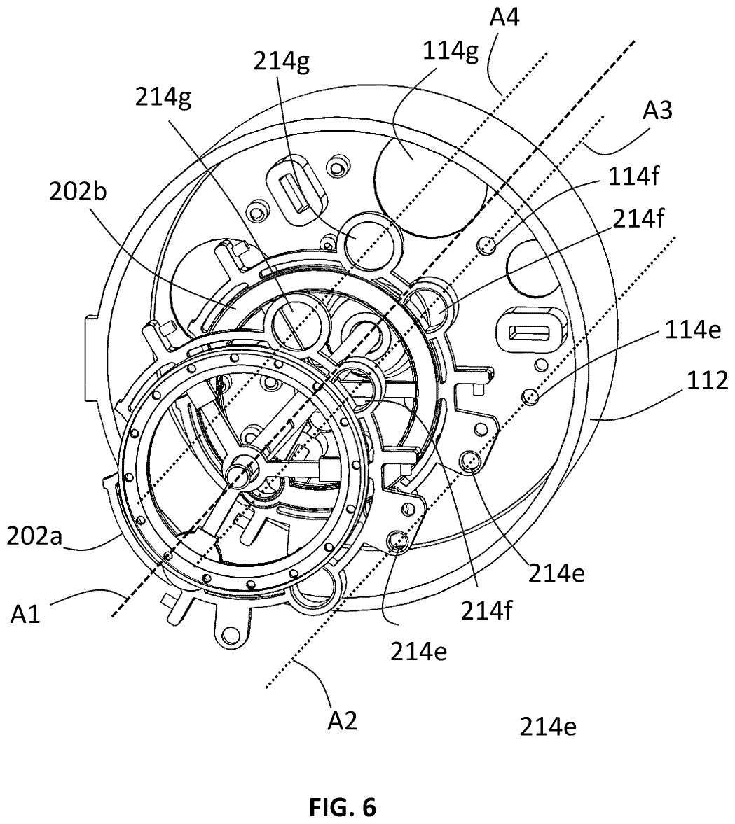

Stirred tank reactor 100, in some embodiments, further includes a headplate 112. Headplate 112 is configured to cap the open proximal end 106 of vessel 102 according to some embodiments. As will be described in further detail herein and shown more clearly in FIGS. 5A, 5B, and 6, headplate 112 may include a plurality of ports 114 (e.g., ports 114a-114g) that extend through headplate 112 and permit various reactor instruments to extend at least partially into the interior of vessel 102. The ports of headplate 112 may be positioned on a top or proximal portion of headplate 112 that is positioned outside of vessel 102. As shown in FIG. 1B, the reactor instruments may optionally include, but are not limited to, cell retention devices (CRD) 402, fluid conduits 404, dip tubes, heat exchangers, sensors, probes, or other devices. A non-limiting example of a CRD that may be utilized in certain embodiments is shown and described in U.S. Pat. No. 11,801,477, which is incorporated herein by reference in its entirety. Optional sensors or probes may include, for example, a temperature probe, a pH probe, a dissolved oxygen probe, a gas sensor, or a biomass sensor. In further embodiments, impeller shaft 110 extends through headplate 112 and is rotatable with respect to headplate 112. In some such embodiments, headplate 112 may include an impeller port 116 that is coaxial with impeller axis A1 and sized to receive impeller shaft 110. In some embodiments, impeller port 116 may be centrally positioned on a top surface of headplate 112 while the additional ports 114 of headplate 112 are radially spaced away from impeller port 116. In some embodiments, impeller port 116 may optionally include a bearing (e.g., ball or roller bearings) that is configured to hold impeller shaft 110 radially in place with respect to headplate 112 and allow rotation of impeller shaft 110 about impeller axis A1 within impeller port 116. In some embodiments, impeller shaft 110 further extends to a motor (not shown) that is configured to cause rotation of impeller shaft 110 and the one or more impellers 108a, 108b, 108c about impeller axis A1. The motor may be positioned on a top or proximal side of headplate 112, outside of vessel 102. In other embodiments, the motor may be positioned at or outside the distal or bottom end of vessel 102.

In further embodiments, stirred tank reactor 100 further includes an internal support system 200 that may be configured to assist in maintaining the position of one or more components within vessel 102 during use. In certain circumstances, without internal support system 200, fluid movement caused by the rotation impeller shaft 110 and the one or more impellers 108a, 108b, 108c during use may cause components within vessel 102 (e.g., cell retention devices (CRD), fluid conduits, dip tubes, heat exchangers, sensors, probes, or other instruments, etc.) to move relative to the vessel 102 during use, particularly at high impeller rotation speeds. For example, these components may be shifted by the shear forces, turbulence, torque, vibrations, and/or other forces caused by the rotation of the one or more impellers 108a, 108b, 108c and/or the movement of the fluid surrounding these components. The movement of these components may, for example, result in loosening of the components, impacts with the rotating impellers, or other suboptimal effects. The internal support system 200 of the present disclosure, at least in some embodiments, may help to attenuate such effects. For example, in some embodiments, internal support system 200 may be configured to restrict and/or prevent the radial movement of components within vessel 102 towards or away from impeller shaft 110 during use. In further embodiments, internal support system 200 may help guide the positioning of the components within vessel 102 such that the components are properly arranged within vessel 102.

In some embodiments, internal support system 200 for stirred tank reactor 100 includes one or more plates 202 that are each securable at a different axial position within vessel 102. As used herein, different axial positions may refer to different locations between distal end 104 and proximal end 106, e.g., along impeller axis A1. In some embodiments, the internal support system includes only one plate 202. In other embodiments, the internal support system includes two plates. In yet other embodiments, the internal support system may include at least two plates, e.g., from two to ten plates. As will be described further herein, in some embodiments, the one or more plates of the internal support system may be secured at the different axial positions such that the one or more plates are fixed in position relative to the vessel 102 and do not move relative to vessel 102 during use. In some embodiments, the one or more plates 202 may be secured directly to vessel 102. In some embodiments, the one or more plates 202 may be secured to one or more other structures 300 (e.g., one or more baffles) that are, in turn, fixed relative to vessel 102. The one or more other structures may be located within vessel 102.

With particular reference to FIG. 2, stirred tank reactor 100 in some embodiments includes an internal support system 200 that includes at least a first plate 202a. In some examples, first plate 202a may be secured relative to vessel 102 at an axial position P1 along impeller shaft A1. In some embodiments, axial position P1 may be a predetermined position between distal end 104 and proximal end 106 of vessel 102. In some embodiments, axial position P1 is a position selected between one or more impellers 108a, 108b, 108c and distal end 104 of vessel 102. Axial position P1 may be located elsewhere along impeller axis A1 according to other embodiments, for example, between one or more impellers 108a, 108b, 108c and proximal end 106 of vessel 102, or between impeller 108a and impeller 108c. In some embodiments, axial position P1 is between distal end 104 and at least one of impellers 108a, 108b, 108c.

In some embodiments, internal support system 200 includes only one plate 202 (e.g., first plate 202a). In other embodiments, internal support system 200 further includes first plate 202a and at least a second plate 202b. Second plate 202b may be secured relative to vessel 102 at an axial position P2 along impeller shaft A1 that is axially spaced from P1. In some embodiments, axial position P2 may be a predetermined position between distal end 104 and proximal end 106 of vessel 102. In some embodiments, axial position P2 is a position selected between one or more impellers 108a, 108b, 108c and proximal end 106 of vessel 102. Axial position P2 may be located elsewhere along impeller axis A1 according to other embodiments, for example, between one or more impellers 108a, 108b, 108c and distal end 104 of vessel 102, or between impeller 108a and impeller 108c. In some embodiments, axial position P2 is between proximal end 106 and at least one of impellers 108a, 108b, 108c. In some embodiments, axial position P2 is between axial position P1 and proximal end 106 of vessel 102. In some embodiments, one or all impellers 108a, 108b, 108c are positioned between axial positions P1 and P2. Other embodiments (not shown) may include more than two plates 202, with the additional plates 202 being axially spaced away from first and second plates 202a, 202b within vessel 102. The two or more plates 202, including first plate 202a and second plate 202b, may be positioned parallel to each other according to some such embodiments. In some examples, when the two or more plates 202 are positioned parallel to each other, the distal (e.g., bottom) face and/or proximal (e.g., top) face of each of the plates 202 may be perpendicular to the impeller axis A1.

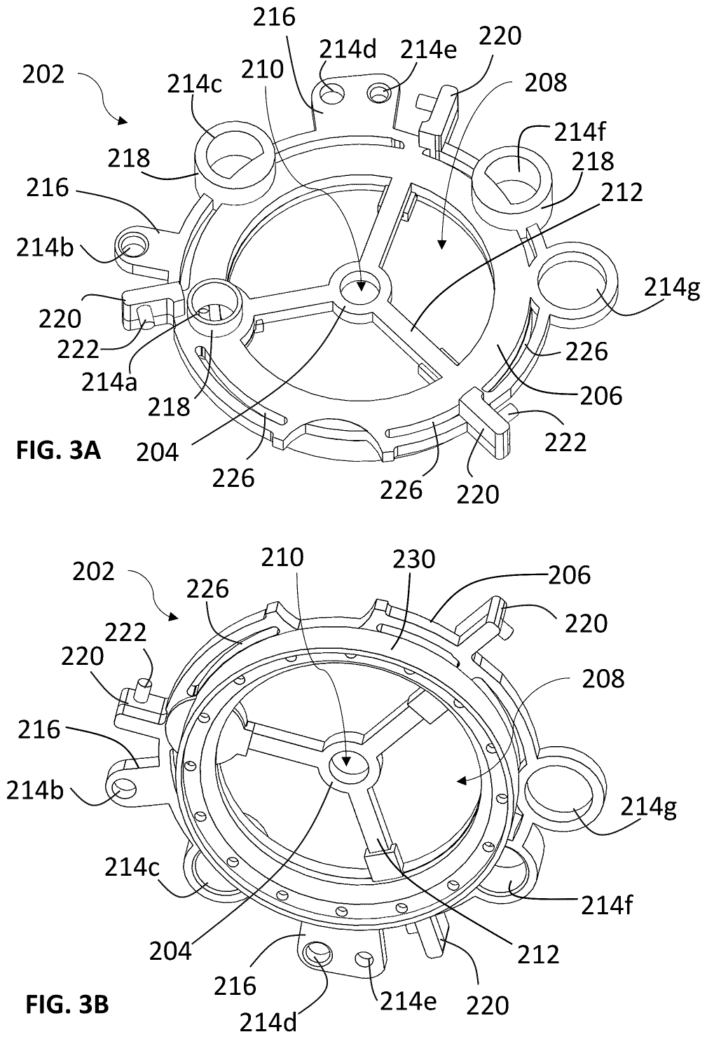

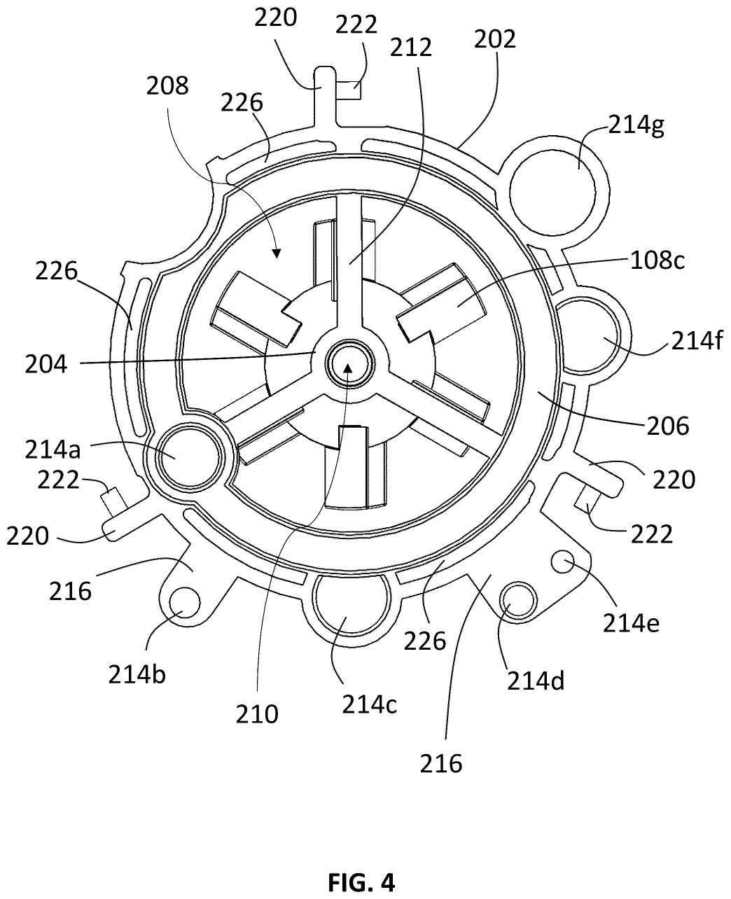

Further details of the one or more plates 202 (e.g., first and second plates 202a, 202b) according to some embodiments are shown in FIGS. 3A-4. In some embodiments, each of the one or more plates 202 includes an inner portion 204 and an outer portion 206 at least partially surrounding the inner portion 204. In some embodiments, outer portion 206 at least partially defines a primary opening 208 with inner portion 204 being positioned within primary opening 208. In some embodiments, primary opening 208 may have a broadest dimension (e.g., diameter) that is larger than a diameter of impellers 108a, 108b, and/or 108c, as illustrated in FIG. 4. The diameter of an impeller may be considered two times the radius of the impeller, the radius of the impeller being the radial distance between a center of the impeller (which intersects with the impeller axis) to the outermost edge of a blade or vane of the impeller. In some embodiments, outer portion 206 includes a ring that encircles primary opening 208 and the broadest dimension of primary opening 208 is an inner diameter of the ring. In some embodiments, outer portion 206 is radially spaced outward from inner portion 204. In some embodiments, outer portion 206 may be concentrically disposed about inner portion 204. In some embodiments, the radially spacing between outer portion 206 and inner portion 204 within primary opening 208 allows for axial flow of fluid through plate 202 between outer portion 206 and inner portion 204. In some embodiments, inner portion 204 may be fixed to outer portion 206 by at least one spoke 212 positioned within primary opening 208 and that extends radially between and connected to inner portion 204 and outer portion 206. In the illustrated embodiments, plate 202 includes at least three spokes 212, though fewer or more spokes may be included in other embodiments.

In some embodiments, inner portion 204 further defines, at least partially, a first central opening 210. In some embodiments, when plate 202 is secured at its respective axial position (e.g., P1 or P2) within vessel 102, impeller axis A1 passes through central opening 210 such that inner portion 204 is disposed at least partially around impeller axis A1. In still further embodiments, central opening 210 and/or primary opening 208 may be coaxial with impeller axis A1 when plate 202 is secured at its respective axial position such that impeller axis A1 passes through a geometric center point of central opening 210 and/or primary opening 208. Central opening 210, according to some embodiments, is sized to receive impeller shaft 110 therethrough. Moreover, impeller shaft 100 is rotatable within central opening 210 with respect to each plate 202 about impeller axis A1. In some such embodiments, central opening 210 may have a broadest dimension (e.g., diameter) that is larger than a diameter of impeller shaft 110 yet smaller than a diameter of impellers 108a, 108b, and/or 108c. In some embodiments, each of outer portion 206 and inner portion 204 may have a generally annular or circular ring shape as illustrated, though other shapes are possible according to other embodiments. In other embodiments, for example, outer portion and/or inner portion 204 may have an arcuate shape (e.g., C-shape) rather than a complete ring shape. In still other embodiments, outer portion 206 and/or inner portion 204 may be polygonal shaped rather than curved.

Plate 202 may be constructed from any material that has sufficient rigidity to resist significant deformation caused by the fluid motion within vessel 102 during use of stirred tank reactor 100. For example, plate 202 may be made of a metal or metal alloy (e.g., stainless steel, aluminum, titanium alloy, etc.), ceramic, glass, plastics, and/or composite materials (e.g., fiber-reinforced polymers). In some embodiments, plate 202 is formed from one or more polymer materials (e.g., one or more thermoplastic resins). Some example polymer materials that can be used to form plate 202 include, but are not limited to, polyamides (e.g., Nylon PA-12), cyclic olefin copolymers, acrylonitrile styrene acrylate, polycyclohexylenedimethylene terephthalate, polyethylene terephthalate, polyether ether ketone, polyetherimide, polyethersulfone, polyethylene, low-density polyethylene, polymethyl methacrylate, polycarbonate, polyphthalamide, and combinations thereof. In some embodiments, the material(s) of plate 202 may be selected to be inert and/or resist corrosion in an aqueous environment. Plate 202 may be formed, for example, by machining, molding, or additive manufacturing, depending on the selected material(s) for plate 202. In some embodiments, plate 202 is of a single-piece construction such that, for example, inner portion 204, outer portion 206, and spokes 212 are formed from a single piece of material. In other embodiments, portions of plate 202 may be constructed separately and then attached together (e.g., by welding, adhesive, mechanical fasteners, adapters that fit together, and/or other fastening means).

In further embodiments, outer portion 206 of each plate 202 includes a plurality of peripheral openings. In some embodiments, the peripheral openings may each be sized and shaped to receive an additional component of stirred tank reactor 100. For instance, in some embodiments, each of the plurality of peripheral openings may receive a reactor instrument as discussed previously. Such reactor instruments may optionally include, for example but not limited to, cell retention devices (CRD) 402, fluid conduits 402, dip tubes, heat exchangers, sensors, probes, etc. In some such embodiments, a reactor instrument may extend at least from a port of headplate 112 to or through one opening of the plurality of peripheral openings of plate 202. As shown in the example embodiment of FIG. 1B, one or more CRD 402 may be held in place between first plate 202a and second plate 202b. In some such embodiments, CRD 402 may have a distal or bottom end that is received in a peripheral opening of first plate 202a and a proximal or top end that is received in a peripheral opening of second plate 202b. Additional tubing may extend from the proximal or top end of CRD 402 to or through a port of headplate 112. In further embodiments, a fluid conduit 402, for example, may be received through one or more peripheral openings in each of first plate 202a and second plate 202b.

With reference again to FIGS. 3A and 3B, the plurality of peripheral openings may include, for example, peripheral openings 214a-214g (also referred to collectively herein as “peripheral openings 214”). However, it should be appreciated that other embodiments may include fewer or more peripheral openings 214 as needed, and the exact number of peripheral openings 214 may be selected depending on the end use of the stirred tank reactor and the number of reactor instruments that are intended to be included. In some embodiments, plurality of peripheral openings 214 are radially spaced from primary opening 208. For example, in some embodiments, a distance between a center point of primary opening 208 and the center point of each opening of plurality of peripheral openings 214 is greater than a radius of primary opening 208. Each opening of the plurality of peripheral openings 214 may be positioned at different radial distances away from central opening 210 such that some of the peripheral openings 214 may be positioned closer to central opening 210 while other peripheral openings 214 are positioned further away from central opening 210. In some embodiments, the center points of the peripheral openings 214 may or may not all lie on a common circle. In some embodiments, the center points of the peripheral openings 214 may or may not all lie in a common plane. Furthermore, the plurality of peripheral openings 214 may or may not be symmetrically arranged on each plate 202 (radial symmetry and/or mirror symmetry). In some embodiments, outer portion 206 may also include one or more radial extensions 216 that project radially outwards from a peripheral edge of each plate 202, and one or more of the peripheral openings 214 may be positioned on each radial extension 218. Radial extensions 216, in some embodiments, may allow placement of one or more of the peripheral openings 214 further away from central opening 210 and, accordingly, further away from impeller shaft 110.

As more clearly illustrated in FIGS. 5A-6, in some embodiments, the plurality of peripheral openings 214 may be arranged such that, when the one or more plates 202 are secured at their respective axial positions (e.g., P1, P2) within vessel 102, each opening of the plurality of peripheral openings 214 on a plate 202 is coaxial with a different port 114 of headplate 112. More particularly, in some embodiments, each opening of the plurality of peripheral openings 214 on a plate 202 is coaxial with a different port 114 of headplate 112 along a separate axis that is parallel to impeller axis A1. In some embodiments, where both first plate 202a and second plate 202b are present, each opening of the plurality of peripheral openings 214 of first plate 202a is coaxial with one opening of the plurality of peripheral openings 214 of second plate 202b, or vice versa.

FIG. 5A provides a bottom plan view of headplate 112 showing an arrangement of ports 114a-114g according to some non-limiting embodiments. In these embodiments, impeller port 116 is centrally positioned on headplate 112 and ports 114a-114g are radially spaced away from impeller port 116 at different distances. Moreover, the ports 114a-114g may have different sizes and/or shapes to accommodate different components, e.g., the aforementioned reactor instruments. The number and positions of ports 114 are not necessarily restricted to the illustrated examples and that other arrangements are well within the scope of the present disclosure. FIG. 5B depicts a plate 202 of internal support system 200 superimposed over the bottom plan view of headplate 112 of FIG. 5A. As shown in these embodiments, each opening of the plurality of peripheral openings 214a-214g is aligned with a separate port 114 of headplate 112. More specifically, the center point of peripheral openings 214a-214g are aligned with the center point of ports 114a-114g, respectively. Moreover, central opening 210 of plate 202 is aligned with impeller port 116. In some embodiments, headplate 112 may include additional ports that are not necessarily aligned with a peripheral opening 214 of plate 202. For example, headplate 112 may include a total number of ports that is greater than the number of peripheral openings 214 on plate 202. Furthermore, the size and shapes of peripheral openings 214 may differ than the sizes and shapes of ports 114 according to some embodiments.

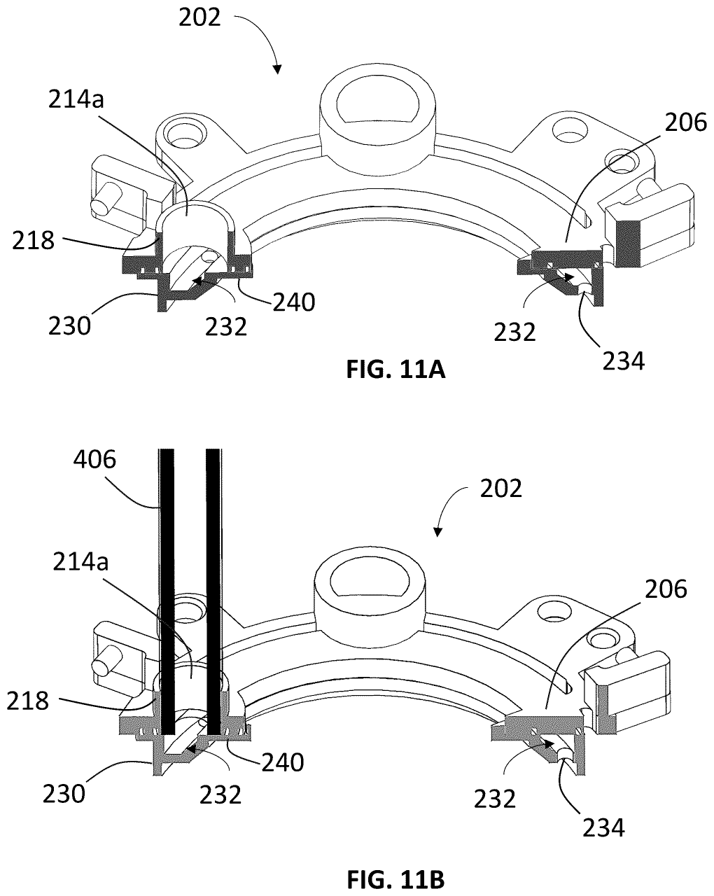

In the perspective view of FIG. 6 that includes at least first plate 202a and second plate 202b, each peripheral openings 214 of first plate 202a may be coaxial with a peripheral opening 214 of second plate 202a and a port 114 of headplate 112. For example, peripheral opening 214e of first plate 202a is coaxial with peripheral opening 214e of second plate 202b and port 114e of headplate 112 along axis A2. In some embodiments, axis A2 passes through center points of peripheral opening 214e of each plate 202a, 202b and port 114e and is parallel to impeller axis A1. Similarly, peripheral opening 214f of first plate 202a is coaxial with peripheral opening 214f of second plate 202b and port 114f of headplate 112 along axis A3, and peripheral opening 214g of first plate 202a is coaxial with peripheral opening 214g of second plate 202b and port 114g of headplate 112 along axis A4. Axis A3 and axis A4 may each be parallel to impeller axis A1. Other coaxial alignments between the peripheral openings 214 of plates 202a, 202b and ports 114 of headplate 112 have not been labeled in FIG. 11 for clarity but may still be understood from the illustration.

Referring once again to FIGS. 3A, 3B, and 4, peripheral openings 214a-214g need not be identical in size and/or shape. For example, in some embodiments, one or more of peripheral openings 214a, 214b, 214d, 214e, and 214g may have generally circular cross-sectional shapes and may be defined by a concave cylindrical surface that is disposed around each opening. The cross-sectional shape of a peripheral opening 214 may be the shape of the peripheral opening 214 in a plan view (e.g., as shown in FIG. 4). Meanwhile peripheral openings 214c and 214f may include a concave cylindrical surface that is only partially disposed around the opening. Other cross-sectional shapes for peripheral openings 214a-214g are also possible according to further embodiments. In some embodiments, one or more of peripheral openings 214a-214g may have a polygonal cross-sectional shape (e.g., triangular, square, rectangular, pentagonal, hexagonal, star, etc.) or another shape that is not necessarily round. In some embodiments, one or more of peripheral openings 214a-214g are shaped such that a particular reactor instrument (e.g., a CRD) may be received in the one or more peripheral openings 214a-214g in only one orientation. Moreover, in some embodiments, one or more openings of peripheral openings 214a-214g may or may not be internally threaded. In still further embodiments, one or more of peripheral openings 214a-214g may be surrounded by a boss 218 that extends perpendicularly from a face (e.g., a proximal or top face) of plate 202. In some such embodiments, bosses 218 may be useful for receiving and/or coupling with the reactor instruments (e.g., cell retention devices). In further embodiments, one or more of the peripheral openings 214 may have a broadest dimension (e.g., diameter) that is greater than the broadest dimension of central opening 210 while other peripheral openings 214 may have a broadest dimension that is equal to or smaller than the broadest dimension of central opening 210. As discussed, in some embodiments one or more peripheral openings 214a-214g are sized and configured to restrict movement of the reactor instruments received therein. Meanwhile, in some embodiments, central opening 210 may also be sized and configured to restrict radial movement of impeller shaft 110. Such configurations may help prevent collisions between impellers 108a, 108b, and/or 108c with the reactor instruments within vessel 102 according to some examples. The restriction on the movement of the reactor instruments provided by plate 202 may also help counteract the vibrations, torque, and/or other forces that may act on the reactor instruments during use. In some embodiments, the extent that the reactor instruments may shift in a radial direction (e.g., toward or away from impeller axis A1) is limited by the dimensions (e.g., diameters) of the one or more peripheral openings 214a-214g. In some embodiments, the size of one or more peripheral openings 214a-214g is configured to have a snug or tight fit around one of the reactor instruments such that the reactor instrument at least partially abuts the surrounding surface that defines the peripheral opening. In some embodiments, the size of one or more peripheral openings 214a-214g may be selected to provide a predetermined clearance (e.g., from about 0.1 mm to about 5 mm) between the reactor instrument and the surrounding surface that defines the peripheral opening. In some embodiments, the predetermined clearance may be selected to be less than 5 mm, less than 4 mm, less than 3 mm, less than 2 mm, less than 1 mm, less than 0.5 mm, less than 0.2 mm, or less than 0.1 mm.

In some embodiments, outer portion 206 of plate 202 may further include one or more slits 226. Slits 226, in some embodiments, provide spaces in outer portion 206 to allow additional axial fluid flow through plate 202. Slits 226, in some embodiments, may be positioned on outer portion 206 least partially between pairs of the peripheral openings 214. In the illustrated embodiments, slits 226 have arcuate shapes that are concentric with primary opening 208. Slits 226, for example, may be narrower in a radial direction and longer in circumferential direction. In some further embodiments, slits 226 may all lie on a common circle that may be concentric with primary opening 208. However, other shapes and arrangements of slits 226 are possible in other embodiments.

As mentioned, in some embodiments a plate 202 of internal support system 200 may be securable to one or more structures 300 that are fixed in position relative to vessel 102. In some such embodiments, the one or more structures 300 are positioned radially outside of the outer portion 206 of the plate 202. In some embodiments, the one or more structures 300 may be attached to or integrally formed with an internal wall of vessel 102. For example, in some embodiments, the one or more structures 300 may include a projection that extends radially inward from the wall of vessel 102 to which plate 202 may be secured. In other embodiments, the one or more structures 300 may include a channel or indent in an internal wall of vessel 102 which may be shaped to receive a portion of plate 202. In still further embodiments, the one or more structures 300 may optionally include, for example, one or more baffles positioned within vessel 102. The one or more baffles may include, for example, elongate members configured and positioned to break the circulating fluid flow pattern, prevent vortex formation, and improve overall mixing within vessel 102. In some embodiments, the one or more baffles may be fixed to the internal walls of vessel 102 and/or fixed to the distal end 104 of vessel 102, for example. In some embodiments, the one or more baffles include elongate members that extend from distal end 104 of vessel 102 to headplate 112 along baffle axes that may be generally parallel to impeller axis A1.

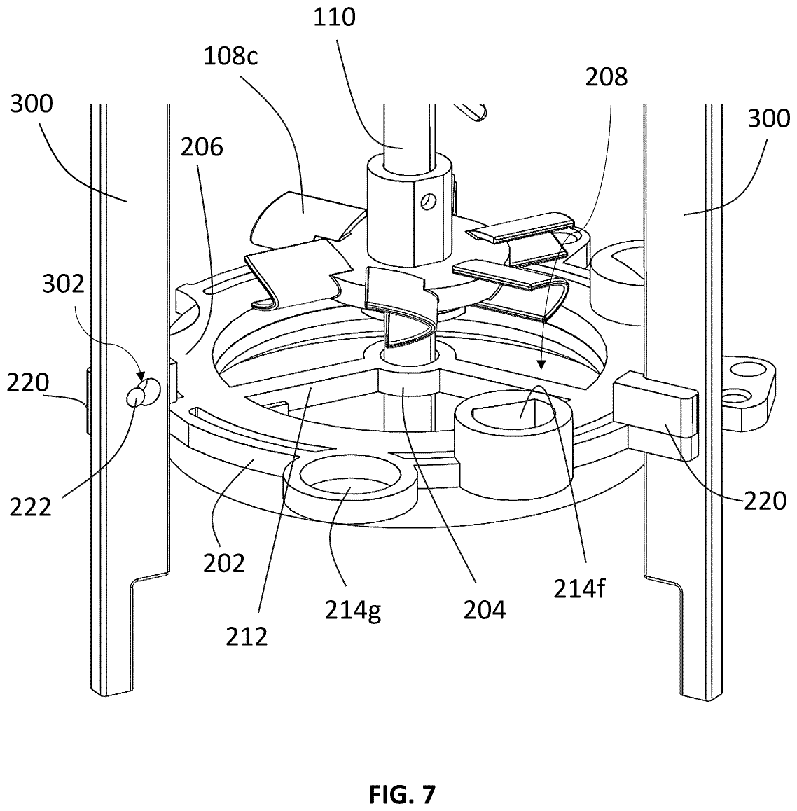

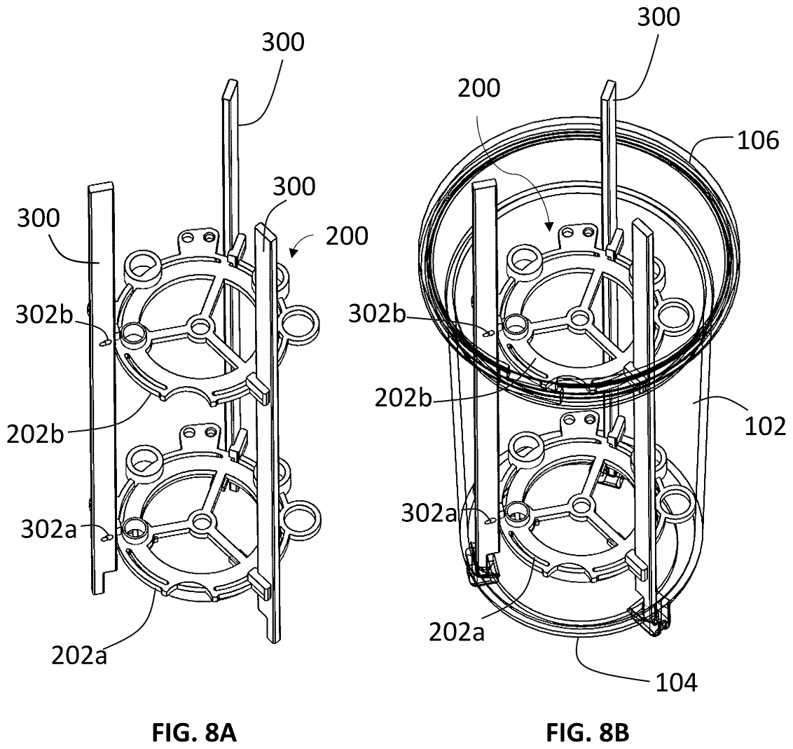

Whether the one or more structures 300 include a baffle or some other element within vessel 102, plate 202 may be secured to structure 300 by several different means. For example, plate 202 may be secured to structure 300 by at least one of adhesion, welding, a magnetic fastener, a mechanical fastener (e.g., pin, bolt, screw, nail, clamp, etc.), and/or a fastener-less joint. A fastener-less joint includes a joint between plate 202 and structure 300 that does not require a separate mechanical fastener or adhesion, for example, a tongue and groove joint, a dovetail joint, a mortise and tenon joint, and/or a lap joint. In some embodiments, plate 202 is engageable with structure 300 by a coupling to secure the plate 202 to structure 300, the coupling including a slot in one of structure 300 and plate 202, and a peg extending from the other one of structure 300 and plate 202 to be received in the slot. As shown for example in FIGS. 3A-4, in some embodiments, plate 202 may include one or more coupling members 220 that extend radially from a periphery of plate 202, the coupling members 220 each having a peg 222 extending orthogonally from the coupling member 220. As shown in FIG. 7, the one or more structures 300, which may be or include one or more vertically extending baffles, includes slots 302 (e.g., keyhole slots) for receiving peg 222 therein. In other embodiments (not shown) the position of the slots and pegs may be reversed such that structures 300 include pegs and plate 202 includes slots for receiving the pegs. In some embodiments, the one or more structures 300 may include other coupling elements for securing to plate 202 instead of or in addition to slots 302 and pegs 222. FIGS. 8A and 8B illustrate first plate 202a and second plate 202b each secured to one or more structures 300 (e.g., baffles) at separate axial positions (e.g., at different points along the height of the one or more structures 300). In some embodiments, structures 300 include slots 302a, 302b or other coupling elements at predetermined locations that correspond to axial positions P1, P2, respectively (as illustrated in FIG. 2) such that first and second plates 202a, 202b can be positioned at the desired axial positions P1, P2 when secured within vessel 102. While not specifically illustrated, the one or more structures 300 may include additional slots or other coupling elements at other axial positions to accommodate more than two plates 202 and/or to allow for first and second plates 202a, 202b to be positioned at different axial positions. In some embodiments, structures 300 may be positioned between the outer portion 206 of plates 202a, 202b and the walls of vessel 102.

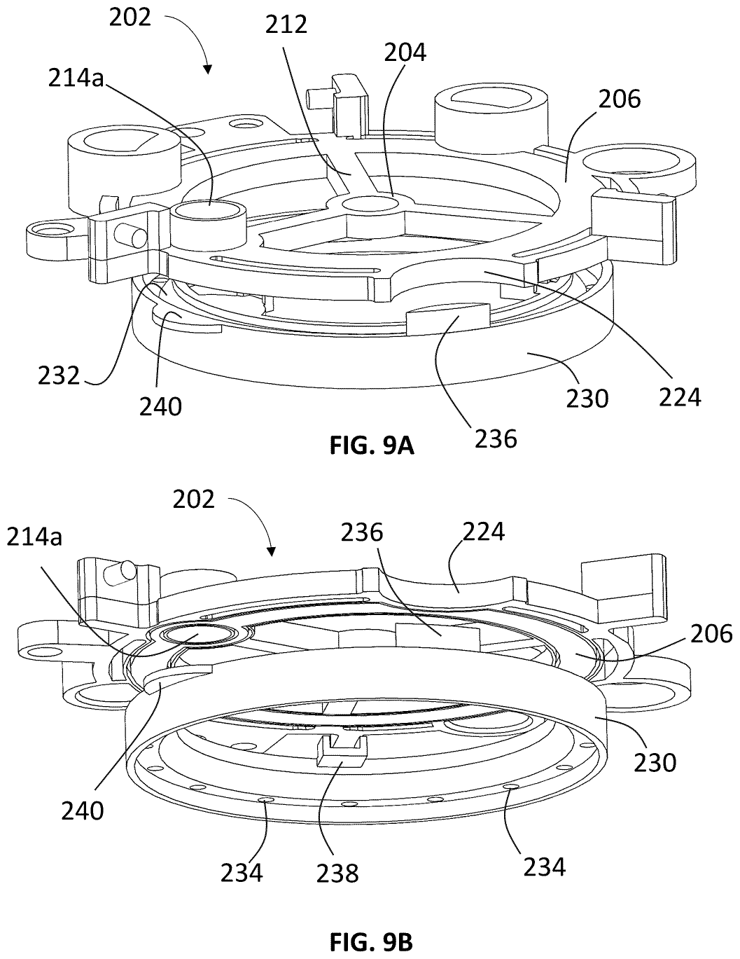

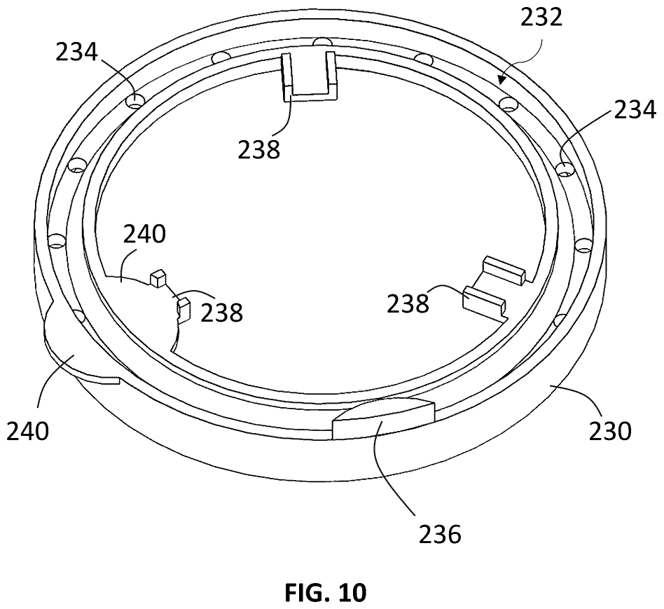

In still further embodiments, stirred tank reactor 100 may include a sparger which is a device configured to introduce gas into the liquid contained in vessel 102 during use. In some embodiments, stirred tank reactor 100 includes a sparger configured as a sparge ring 230. In some embodiments, sparge ring 230 may be positioned between distal end 104 of vessel 102 and one or more of plates 202 of internal support system 200 (e.g., first plate 202a). In some embodiments, sparge ring 230 abuts with a distal or bottom face of a plate 202 of internal support system 200 (e.g., first plate 202a) and may be fixed thereto (e.g., by welding, adhesive, magnetic fasteners, mechanical fasteners, or other types of fastening means). In other embodiments, sparge ring 230 and plate 202 may be formed together as a single component. In some embodiments, sparge ring 230 and plate 202 in combination form a gas conduit that is configured to allow introduction of gas into vessel 102. FIGS. 9A and 9B provide exploded views of a plate 202 and sparge ring 230 according to certain embodiments and FIG. 10 provides an isolated top perspective view of sparge ring 230. Sparge ring 230, in some embodiments, includes a groove 232 that at least partially defines a gas conduit. In some embodiments, groove 232 is open at a proximal or top surface of sparge ring 230. In some embodiments, groove 232 is an annular groove that extends around sparge ring 230 and is coaxial with plate 202. In some embodiments, groove 232 may not form a complete circle or loop. For example, in some embodiments, groove 232 may extend in a U-shaped, C-shaped, horseshoe-shaped, or other open shape.

In further embodiments, sparge ring 230 includes plurality of outlets 234 fluidically coupled to groove 232 and the gas conduit defined by groove 232. In some embodiments, each outlet of the plurality of outlets 234 extends from groove 232 to a surface of sparge ring 230. For example, in some embodiments, outlets 234 may include bores that extend from a bottom of groove 232 to a distal or bottom surface of sparge ring 230. In some embodiments, groove 232 may be at least partially enclosed by the outer portion 206 of a plate 202. More particularly, in some embodiments, a distal face of outer portion 206 of plate 202 may overlay groove 232 such that the distal face of outer portion 206 defines a wall of the gas conduit, as best shown in the cross-sectional views of FIGS. 11A and 11B. In still further embodiments, one of sparge ring 230 and plate 202 includes a keyed feature and the one of sparge ring 230 and plate 202 includes a keyway for receiving the keyed feature such that sparge ring 230 can be coupled to plate 202 in only one orientation with respect to plate 202. In the illustrated embodiment, sparge ring 230 includes a keyed feature that includes a projection 236 on proximal or top surface of sparge ring 230 and outer portion 206 of plate 202 has a keyway including a contoured region 224 that conforms to the shape of projection 236. For example, contoured region 224 of outer portion 206 may include a concavely curved surface that abuts against a convexly curved surface of projection 236 when sparge ring 230 and plate 202 are coupled together. In some embodiments, sparge ring 230 may further include one or more supports 238 for abutting the one or more spokes 212 of plate 212. The one or more supports 238, in some embodiments, may each define a slot that extends radially inward and is sized and configured to receive a spoke 212 of plate 202.

To connect the gas conduit formed between sparge ring 230 and plate 202 to a gas supply, in some embodiments at least one opening of the plurality of peripheral openings 214 may overlay groove 232 when plate 202 is coupled to or formed with sparge ring 230. As shown in FIGS. 11A and 11B, for example, peripheral opening 214a may be positioned on plate 202 to overlay groove 232 of sparge ring 230 and is fluidically coupled therewith. In this embodiment, peripheral opening 214a may serve as an inlet to the gas conduit formed between plate 202 and sparge ring 230. As further shown in FIG. 11B, gas tubing 406 may be used to couple peripheral opening 214a to a gas supply (not shown). In some such embodiments, gas tubing 406 may extend through a port 114 in headplate 112 that is coaxial with peripheral opening 214a. In some embodiments, peripheral opening 214a may include a boss 218 that surrounds a portion of gas tubing 406. In some embodiments, sparge ring 230 may further include a lip or flange 240 that extends radially away from groove 232 and is positioned to support gas tubing 406 and/or peripheral opening 214a. Lip or flange 240 may be sized to seal portions of peripheral opening 214a that extend beyond groove 232 of sparge ring 230 in some embodiments.

One or more components of the stirred tank reactor 100 may be assembled as a kit according to some embodiments of the present disclosure. For example, in some embodiments, a kit may include or consist of one or more plates 202 (e.g., plate 202a and/or plate 202b) alone or together with one or more other components of stirred tank reactor 100. The one or more plates 202 may include a sparge ring 230 in certain embodiments. The sparge ring 230 may be fixed to one plate of the one or more plates 202, or it may be a separate component that can be later fixed to a plate 202 of the kit (e.g., by adhesive, welding, mechanical fastening, etc.). In some embodiments, a kit may include one or more plates 202 and one or more structures 300 (e.g., baffles) to which the one or more plates 202 may be secured, e.g., as described previously. The one or more plates 202 and/or one or more structures 300 may be retrofit within an existing vessel of a stirred tank reactor. In further embodiments, a kit may include at least one or more plates 202, and a vessel 102 and/or headplate 112. In still further embodiments, a kit may include at least one or more plates 202, and one or more reactor instruments (e.g., CRD, fluid conduits, dip tubes, heat exchangers, sensors, probes, or other devices) that are configured to be received within the peripheral openings of the one or more plates 202.

While certain embodiments of the present disclosure have been described in connection with certain instruments and procedures, embodiments described herein are not necessarily limited to these specific uses. Various changes, substitutions, and alterations can be made herein without departing from the spirit and scope of the invention as defined by the appended claims. It should also be apparent that individual elements identified herein as belonging to a particular embodiment may be included in other embodiments of the invention. Moreover, the scope of the present application is not intended to be limited to the particular embodiments of the process, machine, manufacture, and composition of matter, means, methods and steps described in the specification. As one of ordinary skill in the art will readily appreciate from the disclosure herein, processes, machines, manufacture, composition of matter, means, methods, or steps, presently existing or later to be developed that perform substantially the same function or achieve substantially the same result as the corresponding embodiments described herein may be utilized according to the present invention.

1. A stirred tank reactor comprising:
a vessel for containing a liquid, the vessel having a proximal end and a distal end;
an impeller shaft within the vessel disposed along and rotatable about an impeller axis, the impeller axis extending through the proximal end and the distal end of the vessel;
an impeller secured to the impeller shaft within the vessel and rotatable with the impeller shaft about the impeller axis;
a headplate coupled to the proximal end of the vessel having a plurality of ports spaced radially outward from the impeller axis; and
an internal support system positioned within the vessel, the internal support system comprising:
a first plate secured to a first axial position within the vessel along the impeller axis, the first plate including:
a first outer portion at least partially defining a first primary opening having a broadest dimension greater than a diameter of the impeller, the first outer portion including a first plurality of peripheral openings radially spaced from the first primary opening, wherein each opening of the first plurality of peripheral openings is coaxial with a different port of the headplate; and
a first inner portion positioned within the first primary opening and fixed to the first outer portion, the first inner portion disposed about the impeller axis and at least partially defining a first central opening sized to receive the impeller shaft therethrough, the impeller shaft being rotatable with respect to the first inner portion and the first outer portion.

2. The stirred tank reactor of claim 1, wherein the first outer portion comprises a ring that encircles the first primary opening, and wherein the broadest dimension of the first primary opening is an inner diameter of the ring.

3. The stirred tank reactor of claim 1, wherein the first outer portion is disposed concentrically about the first inner portion.

4. The stirred tank reactor of claim 1, wherein the first primary opening is coaxial with the first central opening along the impeller axis.

5. The stirred tank reactor of claim 1, wherein the first central opening has a broadest dimension less than the diameter of the impeller.

6. The stirred tank reactor of claim 1, wherein each opening of the first plurality of peripheral openings is coaxial with a different port of the headplate along a separate axis that is parallel to the impeller axis.

7-9. (canceled)

10. The stirred tank reactor of claim 1, wherein the first plate is securable to a wall of the vessel at the first axial position.

11. The stirred tank reactor of claim 1, wherein the first plate is securable to a structure within the vessel that is fixed in position relative to the vessel.

12. The stirred tank reactor of claim 11, wherein the structure is positioned radially outside of the first outer portion of the first plate.

13-16. (canceled)

17. The stirred tank reactor of claim 11, wherein the structure comprises at least one baffle.

18. The stirred tank reactor of claim 17, wherein the at least one baffle is positioned between the first outer portion of the first plate and a wall of the vessel.

19. The stirred tank reactor of claim 17, wherein the at least one baffle extends along a baffle axis that is parallel to the impeller axis.

20. The stirred tank reactor of claim 18, wherein the at least one baffle extends to the distal end of the vessel.

21. The stirred tank reactor of claim 1, further comprising a sparge ring positioned between the first plate and the distal end of the vessel, the sparge ring at least partially defining a gas conduit and a plurality of outlets fluidically coupled to the gas conduit.

22. The stirred tank reactor of claim 21, wherein the sparge ring is coaxially positioned relative to the first outer portion on a distal face of the first outer portion.

23. The stirred tank reactor of claim 22, wherein the sparge ring is fixed to the distal face of the first outer portion.

24. The stirred tank reactor of claim 21, wherein the gas conduit comprises a groove in a proximal surface of the sparge ring, and wherein each outlet of the plurality of outlets extends from the groove to a surface of the sparge ring.

25. The stirred tank reactor of claim 24, wherein at least some outlets of the plurality of outlets extends from the groove to a distal surface of the sparge ring.

26. The stirred tank reactor of claim 24, wherein the distal face of the first outer portion partially encloses the groove and defines a wall of the gas conduit.

27. The stirred tank reactor of claim 24, wherein an opening of the first plurality of peripheral openings overlays the groove at the proximal surface of the sparge ring and is fluidically coupled to the gas conduit.

28. The stirred tank reactor of claim 24, wherein the groove is an annular groove that is coaxial with the first outer portion.

29. (canceled)

30. The stirred tank reactor of claim 21, wherein one of the sparge ring and the first plate includes a keyed feature and the other one of the sparge ring and the first plate includes a keyway for receiving the keyed feature such that sparge ring can be coupled to the first plate in only one orientation.

31-34. (canceled)

35. The stirred tank reactor of claim 1, wherein the internal support system further comprises:
a second plate secured to a second axial position within the vessel along the impeller axis, the second plate including:
a second outer portion at least partially defining a second primary opening having a broadest dimension greater than a diameter of the impeller, the second outer portion including a second plurality of peripheral openings radially spaced from the second primary opening, wherein each opening of the second plurality of peripheral openings is coaxial with one opening of the first plurality of peripheral openings; and
a second inner portion positioned within the second primary opening and fixed to the second outer portion, the second inner portion disposed about the impeller axis and at least partially defining a second central opening sized to receive the impeller shaft, the impeller shaft being rotatable with respect to the second inner portion and second outer portion.

36. The stirred tank reactor of claim 35, wherein the first axial position is located between the impeller and the distal end of the vessel, and wherein the second axial position is located between the impeller and the proximal end of the vessel.

37. The stirred tank reactor of claim 35, wherein each opening of the second plurality of peripheral openings is further coaxial with a port of the headplate.

38. The stirred tank reactor of claim 35, further comprising a reactor instrument extending through one opening of the first plurality of peripheral openings and one opening of the second plurality of peripheral openings.

39. The stirred tank reactor of claim 38, wherein the reactor instrument further extends through a port of the headplate.

40. The stirred tank reactor of claim 38, wherein the one opening of the first plurality of peripheral openings and the one opening of the second plurality of peripheral openings are sized to prevent radial movement of the reactor instrument towards or away from the impeller shaft.

41. The stirred tank reactor of claim 38, wherein the one opening of the first plurality of peripheral openings and the one opening of the second plurality of peripheral openings are shaped such that the reactor instrument can be received in only one orientation through the one opening of the first plurality of peripheral openings and the one opening of the second plurality of peripheral openings.

42. The stirred tank reactor of claim 38, wherein the reactor instrument comprises at least one of a fluid conduit, a cell retention device (CRD), dip tube, or a sensor.

43-45. (canceled)
